(19) United States
(12) Patent Application Publication
(10) Pub. No.: US 2013/0119320 A1
(43) Pub. Date: May 16, 2013

(54) ELECTROCONDUCTIVE THERMOPLASTIC RESIN

(71) Applicants: Minoru Suyama, Tokyo (JP); Mikio Kobayashi, Tokyo (JP)

(72) Inventors: Minoru Suyama, Tokyo (JP); Mikio Kobayashi, Tokyo (JP)

(73) Assignee: Gensaku TAKAHASHI, Tokyo (JP)

(21) Appl. No.: 13/641,048

(22) PCT Filed: Aug. 25, 2010
(86) PCT No.: PCT/JP2010/064415

§ 371 Date: Jan. 22, 2013

(30) Foreign Application Priority Data
Apr. 14, 2010 (JP) 2010-092756

(51) Int. Cl. H01B 1/24

(52) U.S. Cl. CPC H01B 1/24
USPC 252/509; 252/511

(57) ABSTRACT

In a tumbler and the like, polypropylene pellets are blended with 1 to 5 wt. % of carbon nanotubes, 10 to 30 wt % of fly ash, 10 to 20 wt % of talc and 0.3 to 1 wt % of a modifier, the resulting blend is extruded from a screw extruder while heating the blend to a melting temperature of about 160 to 260° C., to generate a strand. This strand is cooled and cut into pellets having a predetermined length. Owing to blending with fly ash, talc and a modifier, an inexpensive lightweight electroconductive thermoplastic resin excellent in dust-proofness, heat resistance and recyclability is obtained, even if the blending amount of carbon nanotubes is small.

### TECHNICAL FIELD

The present invention relates to an inexpensive lightweight electroconductive thermoplastic resin excellent in dust-proofness, heat resistance and recyclability.

### BACKGROUND ART

Since semiconductor devices, optical lenses and the like are highly precise components, packaging containers, conveying trays and the like thereof are required to have sufficient dust-proofness to prevent adherence of dusts during packaging or conveyance. For these packaging containers, conveying trays and the like to satisfy the requirement of dust-proofness, it is usually required that the surface intrinsic resistance value is in the range of 10⁴ to 10⁹ Ω. It is necessary to previously heat these packaging containers, conveying trays and the like to remove moisture since if moisture adheres to the surface, there is a possibility of occurrence of electrical interference and the like in the semiconductor device. It is also necessary to perform annealing to relax molding strain. For this reason, packaging containers, conveying trays and the like for semiconductor devices and the like are required to have heat resistance against the heat drying and annealing.

Conventionally, electroconductive synthetic resins scarcely generating static electricity are used as the material of packaging containers, conveying trays and the like for semiconductor devices and the like. As such synthetic resins, there is a suggestion, for example, on resins obtained by blending a thermoplastic resin such as polycarbonate and the like with electroconductive carbon black to impart electrical conductivity (see, patent document 1).

However, if the blending amount of electroconductive carbon black is increased for ensuring electrical conductivity in the synthetic resin described in patent document 1, there occurs a problem that carbon peels off from the surface of a packaging container, a conveying tray and the like to contaminate and damage the semiconductor device and the like. Though the synthetic resin described in patent document 1 has a heat resistant temperature of about 130° C. since it is a so-called crystalline thermoplastic resin, heating at higher temperature is necessary for removing moisture more quickly. Therefore, it is needed to further raise the heat resistant temperature.

Then, there is a suggestion on those in which carbon nanotubes manifesting excellent electrical conductivity at low amount are blended instead of carbon black for preventing peeling off of carbon, and an amorphous resin excellent in heat resistance such as modified polyphenylene oxide and the like is used instead of a crystalline resin for further improving heat resistance (see, patent document 2). Further, there is a suggestion on those comprising a crystalline resin blended with carbon nanotubes, in which carbon fiber is blended for further improving heat resistance and electrical conductivity (see, patent document 3).

For articles made of a thermoplastic resin, and the like, mixing of an inorganic filler for improving rigidity, strength and the like is widely conducted. Methods are suggested for blending fly ash recovered by a dust collector from a combustion gas of a powdered coal combustion boiler, in addition to calcium carbonate, talc and the like, as this inorganic filler (see, e.g., patent documents4 and 5).

### PRIOR TECHNOLOGICAL DOCUMENTS

### Patent Document

Patent document 1: JP-A No. 2008-141130
Patent document 2: JP-A No. 2008-231426
Patent document 3: JP-A No. 2005-200620
Patent document 4: JP-A No. 06-170952
Patent document 5: JP-A No. 2003-48268

### SUMMARY OF THE INVENTION

### Problem to be Solved by the Invention

Because of use of an amorphous resin, however, the electroconductive resin described in patent document 2 has problems of high cost and difficulty in weight saving of a packaging container, a conveying tray and the like due to large specific gravity thereof.

Further, the electroconductive resin described in patent document 3 has problems of increased cost and difficulty in weight saving since carbon fiber which is expensive and having large specific gravity is blended in large amount. That is, claim 8 and the like of patent document 3 describe a blending rate of carbon fiber of as extremely wide as 10 to 70 wt %, however, the range described as confirmed by tests is limited to a case of blending carbon fiber in an amount of as large as 50 to 65 wt %. When such a large amount of carbon fiber is blended, its cost rises and its specific gravity increases.

Thus, the present invention has an object of providing an inexpensive lightweight electroconductive thermoplastic resin excellent in dust-proofness, heat resistance and recyclability.

### Means for Solving the Problem

The present inventors have intensively studied and experimented and resultantly found that if a crystalline thermoplastic resin is blended with coal ash such as fly ash and the like used as a filler for improving the mechanical strength of a synthetic resin together with an inorganic filler such as talc and the like and a modifier (compatibilizing agent), an excellent antistatic effect is manifested, leading to the present invention based on this finding.

That is, it has been found that, coal ash such as fly ash and the like contains aluminum, iron and magnesium oxides and if a synthetic resin is blended with coal ash such as fly ash and the like containing such metal oxides, electrical conductivity is enhanced. Further, it has been found that if a small amount of a modifier (compatibilizing agent) is added in addition to fly ash and the like, spherical crystal particles of fly ash and the like are uniformly dispersed, and mutually come close to give easy contact, more enhancing electrical conductivity. It has been found that if further an inorganic filler such as talc and the like is added in addition to this, this talc and the like makes an invasion into gaps between crystal particles of fly ash and the like, resultantly pressing mutually crystal particles of fly ash and the like to give a dense condition, further enhancing electrical conductivity.

Then, it has been found that when even an inexpensive crystalline thermoplastic resin is blended with coal ash such as fly ash and the like, an inorganic filler such as talc and the like, and a modifier, electrical conductivity necessary for ensuring dust-proofness of a packaging container, a conveying tray and the like(surface intrinsic resistance value: 10⁴ to 10⁹ Ω) is obtained by blending a small amount of carbon nanotubes.

That is, the electroconductive thermoplastic resin according to the present invention is characterized in that a crystalline thermoplastic resin is blended with 1 to 5 wt % of carbon nanotubes, 10 to 30 wt % of coal ash generated in a powdered coal combustion boiler, 10 to 20 wt % of an inorganic filler and 0.3 to 1 wt % of a modifier.

Here, “carbon nanotubes” are known materials, mean a macromolecule structure formed by cylindrical bonding of carbon atoms, and manifest high electrical conductivity. The reason for a blending rate of “1 to 5 wt %” is that when less than 1 wt %, an antistatic effect may possibly be deficient, while when over 5 wt %, electrical conductivity is too high to generate a possibility of occurrence of polarization and the like. Here, the blending rate of “carbon nanotubes” is more desirably 1 to 3 wt %. The reason for this is that owing to the smaller blending rate of “carbon nanotubes”, the intended electrical conductivity (surface intrinsic resistance value: 10⁴ to 10⁹ Ω) can be attained

“Coal ash generated in a powdered coal combustion boiler” means “fly ash” collected by a dust collector from a combustion gas of a powdered coal combustion boiler used in a thermal electric generation plant and the like, and “clinker” dropped and collected at the furnace bottom of a powdered coal combustion boiler. Both substances are a fine powder containing components such as SiO₂, Al₂O₃, Fe₂O₃, CaO, MaO, SO₃ and the like. “Coal ash generated in a powdered coal combustion boiler”includes, in addition to a single body of “fly ash” or “clinker”, also a mixture containing both substances. The average particle size of coal ash is desirably about 10 to 30 μm.

The reason for a blending rate of “10 to 20 wt %” is that when less than 10 wt %, electrical conductivity lowers to possibly cause deficiency of an antistatic effect, while when over 20 wt %, a chargeable thermoplastic resin becomes brittle.

“Inorganic filler” is desirably“talc” and includes also calcium silicate, aluminum silicate, bentonite, zeolite, basic magnesium carbonate, volcanic ash, natural gypsum, attapulgite, quartz powder, kaolin clay, light calcium carbonate, chalk, heavy calcium carbonate, pyrophyllite clay, cerussite, dolomite powder, mica, calcium sulfate, silicon carbide powder, magnesium oxide, titanium oxide, precipitated barium sulfate, barite and the like. “Talc” means an inorganic powder obtained by pulverizing talcum, and its chemical name is hydrated magnesium silicate [Mg₃Si₄O₁₀(OH)₂].

The reason for a blending rate of “10 to 20 wt %” is that when less than 10 wt %, electrical conductivity lowers to cause a possibility of deficiency of an antistatic effect, while when over 20 wt %, impact strength lowers to generate brittleness, and specific gravity increases to cause difficulty in weight saving, and further, the price per unit weight increases.

“Modifier” means what is called “compatibilizing agent”, and means an additive for more effective dispersion of an inorganic substance (coal ash or the like) and for obtaining contact chain of crystal particles of coal ash and the like, when a thermoplastic resin is blended with an inorganic substance and the blend is compounded, and in the present invention, means an additive for making coal ash blended in a thermoplastic resin to be uniformly dispersed in this thermoplastic resin, to attain mutually close contact condition. Examples thereof include “ADTEX ER320P, ER333F-2, ER353LA and ER313E-1” manufactured by Japan Polychem Corporation, “Taftech P2000 and H1043” manufactured by Asahi Kasei Corporation, “Modic P533A, P502, P565 and P908” manufactured by Mitsubishi Chemical Corporation, and “EBFF” and “Excel T-95” manufactured by Kao Corporation.

The reason for a blending rate of “0.3 to 1 wt %” is that when less than 0.3 wt %, electrical conductivity lowers to cause a possibility of deficiency of an antistatic effect, while when over 1 wt %, the resin surface becomes sticky, thereby easily incurring contamination and damages. Here, the blending rate of “modifier” is more desirably 0.6 to 1 wt %, since the influence of the blending rate on electrical conductivity becomes approximately constant in this range.

Further, the present inventors have found that if the above-described electroconductive thermoplastic resin is blended with glass fiber, generation of warpage can be suppressed. That is, this electroconductive thermoplastic resin is characterized in that the above-described crystalline thermoplastic resin is further blended with 5 to 25 wt % of glass fiber and 4 to 6 wt % of a coupling agent.

Here, “glass fiber” means fiber having a general glass composition like E-glass, and any compositions can be used providing that glass fiber can be formed, and there is no specific restriction of the composition. The reason for a blending rate of glass fiber of 5 to 25 wt % with respect to a thermoplastic resin is that when less than 5 wt %, sufficient suppression of generation of warpage is difficult, while when over 25 wt %, specific gravity increases. This glass fiber blending rate is more desirably 8 to 16 wt %. The fiber length of glass fiber is desirably 1 to 10 mm, more desirably 3 to 8 mm. The reason for this is that when less than 1 mm, sufficient suppression of generation of warpage is difficult, while even when over 10 mm, more increase in the warpage suppressing effect is not obtained.

“Coupling agent” is blended to improve adhesion at an interface between glass fiber and a thermoplastic resin, and tensile strength, impact strength, water resistance and the like are improved by this. Here, the reason for “blending 4 to 6 wt % is that when less than 4 wt %, impact strength and the like are deficient, while even when over 6 wt %, more improvement in adhesion is not obtained.

As “coupling agent”, known agents may be used, and examples thereof include “ADTEX ER320P” manufactured by Japan Polychem Corporation.

The present inventors have found that if carbon fiber is blended in addition to the above-described components, electrical conductivity and heat resistance are improved. That is, this electroconductive thermoplastic resin is characterized in that a crystalline thermoplastic resin is blended with 1 to 2 wt % of carbon nanotubes, 5 to 30 wt % of carbon fiber, 10 to 30 wt % of coal ash generated in a powdered coal combustion boiler, 10 to 20 wt % of an inorganic filler and 0.3 to 1 wt % of a modifier.

Here, “carbon fiber” is a known fibrous carbon substance having a fine graphite crystal structure, and generated, for example, by combusting organic fiber made of an acrylic resin or pitch obtained from petroleum or coal. The reason for a blending rate of carbon fiber of 5 to 30 wt % is that when the blending rate of carbon nanotubes is in the range of 1 to 2 wt %, if the blending rate of carbon fiber is less than 5 wt %, electrical conductivity lowers to cause a possibility of deficiency of an antistatic effect, while if over 30 wt %, electrical conductivity is too high to cause a possibility of generation of polarization and the like and specific gravity increases to cause difficulty in weight saving.

Also, the present inventors have found that when the blending rate of carbon nanotubes is in the range of 1 to 3 wt %, if the blending rate of carbon fiber is 5 to 20 wt %, the intender surface intrinsic resistance value (10⁴ to 10⁹ Ω) can be attained. That is, this electroconductive thermoplastic resin is characterized in that a crystalline thermoplastic resin is blended with 1 to 3 wt % of carbon nanotubes, 5 to 20 wt % of carbon fiber, 10 to 30 wt % of coal ash generated in a powdered coal combustion boiler, 10 to 20 wt % of an inorganic filler and 0.3 to 1 wt % of a modifier.

Further, the present inventors have found that when the blending rate of carbon nanotubes is in the range of 0.5 to 2 wt %, if the blending rate of carbon fiber is 20 to 30 wt %, the intended surface intrinsic resistance value (10⁴ to 10⁹ Ω) can be obtained. That is, this electroconductive thermoplastic resin is characterized in that a crystalline thermoplastic resin is blended with 0.5 to 2 wt % of carbon nanotubes, 20 to 30 wt % of carbon fiber, 10 to 30 wt % of coal ash generated in a powdered coal combustion boiler, 10 to 20 wt % of an inorganic filler and 0.3 to 1 wt % of a modifier.

The above-described inorganic filler is desirably talc.

Further, it is more desirable that the above-described crystalline thermoplastic resin is any one of polypropylene, polyvinylidene fluoride, polyphenylene ether, polyphenylene oxide, polyamideimide, polycarbonate, polystyrene and ABS, or a combination of two or more of them.

### Effect of the Invention

By blending a crystalline thermoplastic resin with coal ash such as fly ash and the like, an inorganic filler such as talc and the like, and a modifier, a surface intrinsic resistance value of 10⁴ to 10⁹ Ω can be attained even if the blending rate of carbon nanotubes is as low as 1 to 5 wt %. Since the blending rate of carbon nanotubes is extremely low, generation of powder detachment can be surely prevented. Further, specific gravity can be suppressed to about 1.1 while ensuring heat resistance at 130° C. By use of a crystalline thermoplastic resin, significant cost down is possible as compared with an amorphousthermoplastic resin. Further, recyclability can be ensured by which properties do not vary even in re-use.

Further, by blending 5 to 25 wt % of glass fiber and 4 to 6 wt % of a coupling agent with respect to the above-described crystalline thermoplastic resin, generation of warpage can be suppressed.

By blending 5 to 30 wt % of carbon fiber, a surface intrinsic resistance value of 10⁴ to 10⁹ Ω can be attained and generation of powder detachment can be surely prevented even if the amount of carbon nanotubes is as extremely low as 1 to 2 wt %. Further, the heat resistant temperature can be raised to 140° C. or higher while suppressing increase in specific gravity.

If the range of the blending rate of carbon nanotubes is enlarged to the upper limit side such as 1 to 3 wt %, a surface intrinsic resistance value if 10⁴ to 10⁹ Ω can be attained even if the blending rate of carbon fiber is reduced to the lower limit side such as 5 to 20 wt %. Therefore, by decreasing the blending rate of carbon fiber, it becomes possible to lower cost and specific gravity.

Further, a surface intrinsic resistance value of 10⁴ to 10⁹ Ω can be attained, also by reducing the blending rate of carbon fiber to the upper limit side such as 20 to 30 wt % by enlarging the range of the blending rate of carbon nanotubes to the lower limit side such as 0.5 to 2 wt %. Therefore, generation of powder detachment can be surely prevented by decreasing the blending rate of carbon nanotubes.

### BRIEF EXPLANATION OF DRAWINGS

FIG. 1 is a schedule table showing the component blending rate and the surface intrinsic resistance value and the like in examples and comparative examples.

FIG. 2 is a graph showing a relation between the surface intrinsic resistance value and the blending rate of carbon nanotubes.

FIG. 3 is a graph showing a relation between the surface intrinsic resistance value and the blending rate of carbon fiber.

FIG. 4 is a graph showing a relation between the heat resistant temperature and the blending rate of carbon fiber.

FIG. 5 is a graph showing a relation between the specific gravity and the blending rate of carbon fiber.

FIG. 6 is a table showing the blending rate of fly ash and the measured data of the surface intrinsic resistance value.

FIG. 7 is a table showing the blending rate of talc and the measured data of the surface intrinsic resistance value.

FIG. 8 is a table showing the blending rate of a modifier and the measured data of the surface intrinsic resistance value.

FIG. 9 is a graph showing a relation between the surface intrinsic resistance value and the blending rate of fly ash.

FIG. 10 is a graph showing a relation between the surface intrinsic resistance value and the blending rate of talc.

FIG. 11 is a graph showing a relation between the surface intrinsic resistance value and the blending rate of a modifier.

FIG. 12 is a table showing properties in the case of blending glass fiber.

### Best Modes for Carrying Out the Invention

For obtaining the electroconductive thermoplastic resin according to the present invention, for example, in a tumbler and the like, 58 wt % of pellets of polypropylene as a crystalline thermoplastic resin(for example, “Sun Allomer PM900A” manufactured by Sun Allomer Ltd.) are blended with 2 wt % of carbon nanotubes (for example, vapor grown carbon fiber “VGCF(registered trademark)-X” manufactured by Showa Denko K.K.:fiber diameter 15 nm, fiber length 3 nm), 15 wt % of carbon fiber(for example, “T300B-12000” manufactured by Toray Industries Inc.), 15 wt % of fly ash having a particle size of 10 to 30 μm (for example, article manufactured by J Power/EPDC), 10 wt % of talc having a bulk specific volume of 0.9 to 1.2 ml/g(for example, “MS-P” manufactured by Nippon Talc Co., Ltd.) and 0.6 wt % of a modifier(for example, “Excel T-95” manufactured by Kao Corporation).

This blend is extruded from a screw extruder while heating the blend to a melting temperature of about 160 to 260° C., to generate a strand. This strand is cooled while moving on a conveyor. The surface-cooled strand is cut into pellets having a predetermined length by a rotary cutter. For making detachment from the screw extruder easy, a lubricant (for example, “ca-st”manufactured by Nitto Kasei Co., Ltd.) and an antioxidant(for example, “AO-60” manufactured by ADEKA Corporation) are blended each in an amount of 0.1 wt %.

The surface intrinsic resistance value of the above-described pellets was measured by a surface resistivity tester (“Lorester AP” manufactured by Mitsubishi Petrochemical Co., Ltd.) to find the value of 10⁶ Ω. The heat resistant temperature of the above-described pellets was measured according to JIS K7191 “Plastics—Determination of temperature of deflection under load” to find a value of 150° C. Further, the above-described pellets had a specific gravity of 1.193, smaller by about 5% as compared with those obtained by using an amorphous resin according to conventional technologies (see, patent document 2).

### EXAMPLES

Examples and comparative examples of the electroconductive thermoplastic resin according to the present invention will be shown. Components constituting this electroconductive thermoplastic resin are as described below. That is, pellets of polypropylene “SunAllomer PM900A” manufactured by SunAllomer Ltd. as a crystalline thermoplastic resin, vapor grown carbon fiber “VGCF(registered trademark)-X” (fiber diameter 15 nm, fiber length 3 nm)manufactured by Showa Denko K.K. as carbon nanotubes, “T300B-12000” manufactured by Toray Industries Inc. as carbon fiber, fly ash having an average particle size of 10 to 30 μm manufactured by J Power/EPDC as coal ash, “MS-P” manufactured by Nippon Talc Co., Ltd. as talc, “Excel T-95” manufactured by Kao Corporation as a modifier, “ca-st” manufactured by Nitto Kasei Co., Ltd. as a lubricant, and “AO-60” manufactured by ADEKA Corporation as an antioxidant were used.

The above-described components were blended in a tumbler and the like, the resultant blend was extruded from a screw extruder while heating the blend to a melting temperature of about 160 to 260° C., to generate a strand, and this strand was cooled while moving on a conveyor. The surface-cooled strand was cut by a rotary cutter to make pellets. The pellets were injection-molded, to fabricate a sample in the form of a plate.

The surface intrinsic resistance value of the above-described sample was measured by a surface resistivity tester (“Lorester AP” manufactured by Mitsubishi Petrochemical Co., Ltd.). The heat resistant temperature was measured according to JIS K7191 “Plastics—Determination of temperature of deflection under load”. Further, the specific gravity was measured using an automatic specific gravity measuring instrument “D-8” manufactured by Toyo Seiki Co., Ltd.

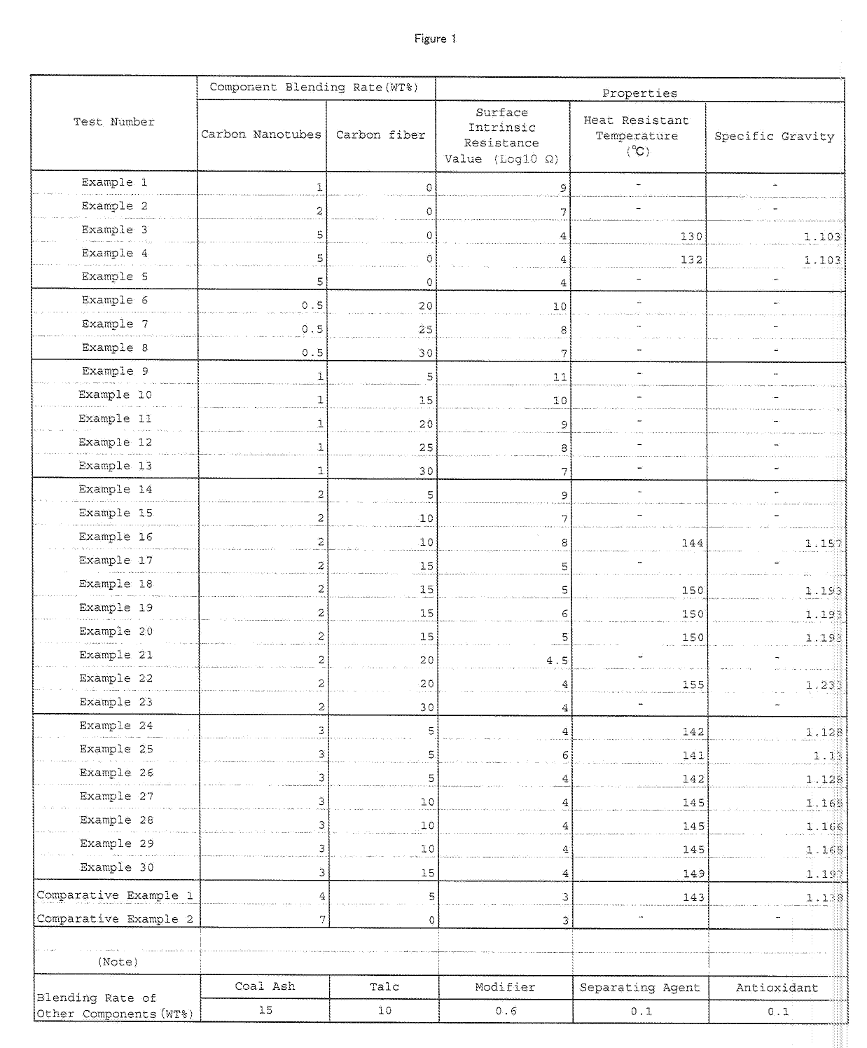

FIG. 1 shows the blending rates (wt %) of carbon nanotubes and carbon fiber and the measured results of the surface intrinsic resistance value (Ω), the heat resistant temperature(° C.) and the specific gravity, of the above-described sample. The blending rates of other components were 15 wt % of fly ash, 10 wt % of talc, 0.6 wt % of a modifier, 0.1 wt % of a separating agent and 0.1 wt % of antioxidant.

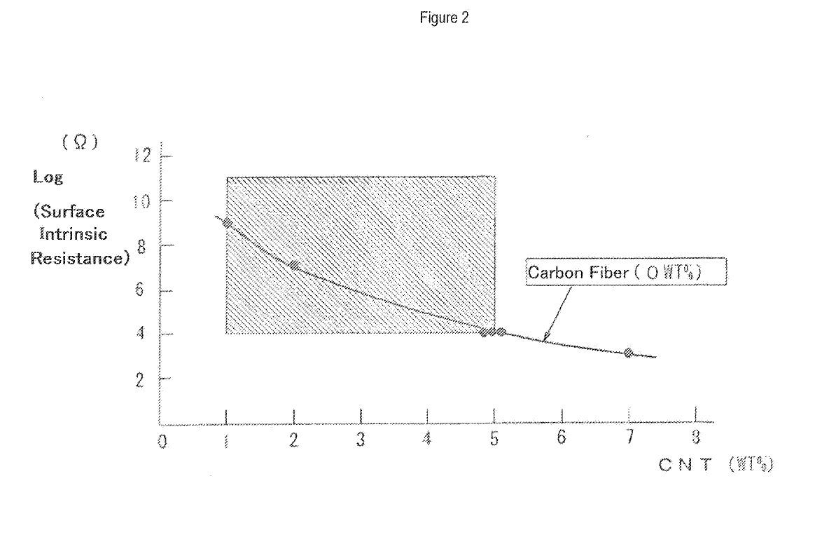

In Examples 1 to 5 shown in FIG. 1, the blending rate of carbon nanotubes(CNT) was changed from 1 to 5 wt % without blending carbon fiber. In Comparative Example 2, the blending rate of carbon nanotubes was set at 7 wt % without blending carbon fiber. FIG. 2 shows a relation between the surface intrinsic resistance value (Ω) and the blending rate of carbon nanotubes, for Examples 1 to 5 and Comparative Example 2. As shown in FIG. 2, it could be confirmed that an intended surface intrinsic resistance value of 10⁴ to 10¹¹ Ω, can be attained by blending carbon nanotubes in an amount of as small as 1 to 5 wt % even if carbon fiber is not blended.

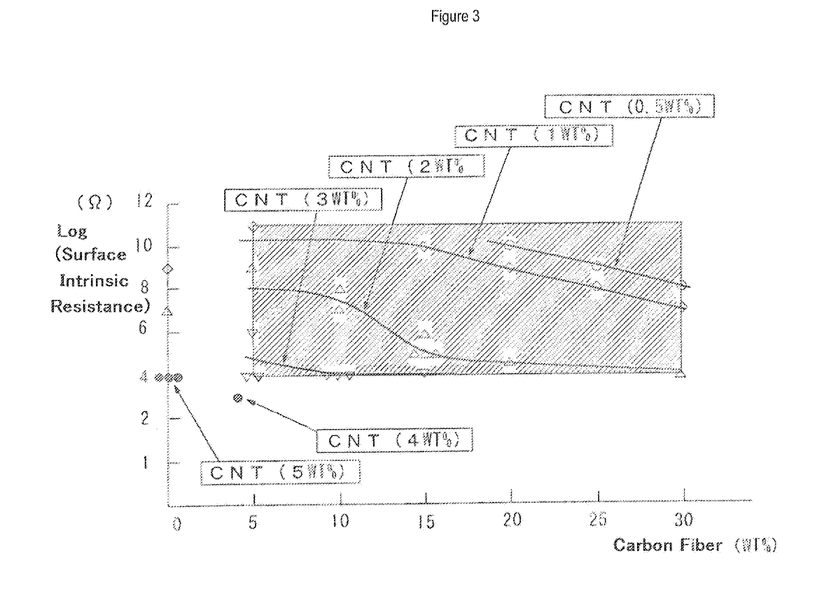

In Examples 6 to 30 and Comparative Example 1 shown in FIG. 1, carbon fiber is mixed, and the blending rate of this carbon fiber is changed from 5 to 30 wt % and the blending rate of carbon nanotubes is changed from 0.5 to 4 wt %. FIG. 3 shows a relation between the surface intrinsic resistance value (Ω) and the blending rate of carbon nanotubes, for Examples 1 to 30 and Comparative Example 1. As shown in FIG. 3, it could be confirmed that an intended surface intrinsic resistance value of 10⁴ to 10¹¹ Ω can be attained by blending carbon nanotubes in an amount of as extremely small as 1 to 2 wt % when 5 to 30 wt % of carbon fiber is blended.

As shown in FIG. 3, it could be confirmed that an intended surface intrinsic resistance value of 10¹¹ to 10⁴ Ω can be attained by blending 1 to 3 wt % of carbon nanotubes when the blending rate of carbon fiber is in the range of 5 to 20 wt %. Further, it could be confirmed that an intended surface intrinsic resistance value of 10⁴ to 10¹¹ Ω can be attained by blending 0.5 to 2 wt % of carbon nanotubes when the blending rate of carbon fiber is in the range of 20 to 30 wt %.

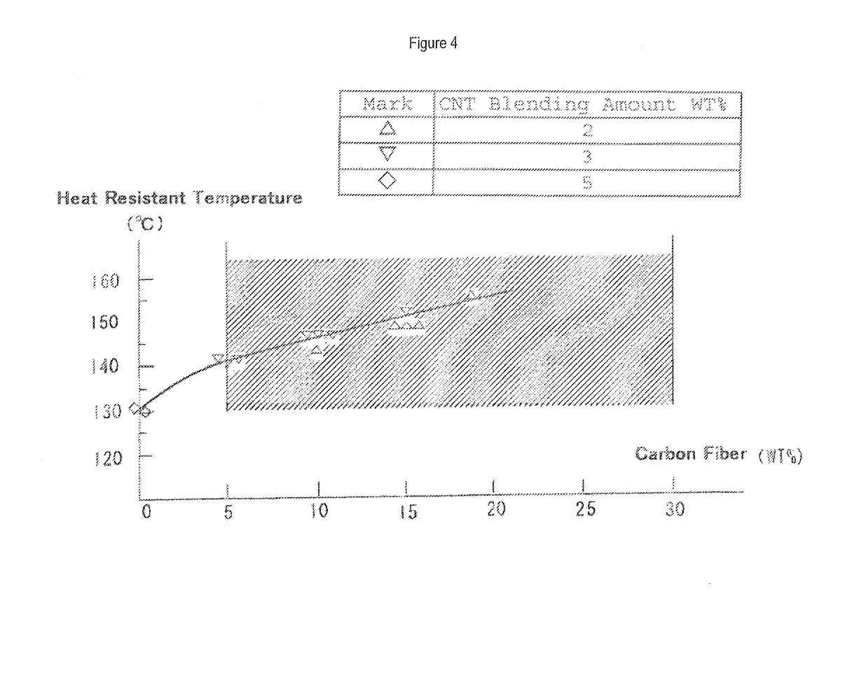

FIG. 4 shows a relation between the heat resistant temperature and the blending rate of carbon fiber, for the cases of measurement of the heat resistant temperature among Examples 1 to 30. That is, FIG. 4 shows a relation between the heat resistant temperature and the blending rate of carbon fiber when the blending rate of carbon nanotubes is set at 2, 3 and 5 wt % when the blending rate of carbon fiber is in the range of 0 to 30 wt %. As shown in FIG. 4, when carbon fiber is not blended, the heat resistant temperature is about 130° C., however, the heat resistant temperature rises when the blending rate of carbon fiber increases. That is, it could be confirmed that when the blending rate of carbon fiber is 5 wt % or more, the heat resistant temperature rises to 140° C. or higher, and when the blending rate of carbon fiber is 15 wt % or more, the heat resistant temperature rises to 150° C. or higher. Since the heat resistant temperature rises approximately linearly when the blending rate of carbon fiber is in the range of 5 to 20 wt %, it can be expected that the heat resistant temperature further rises when the blending rate of carbon fiber is in the range of 20 to 30 wt %.

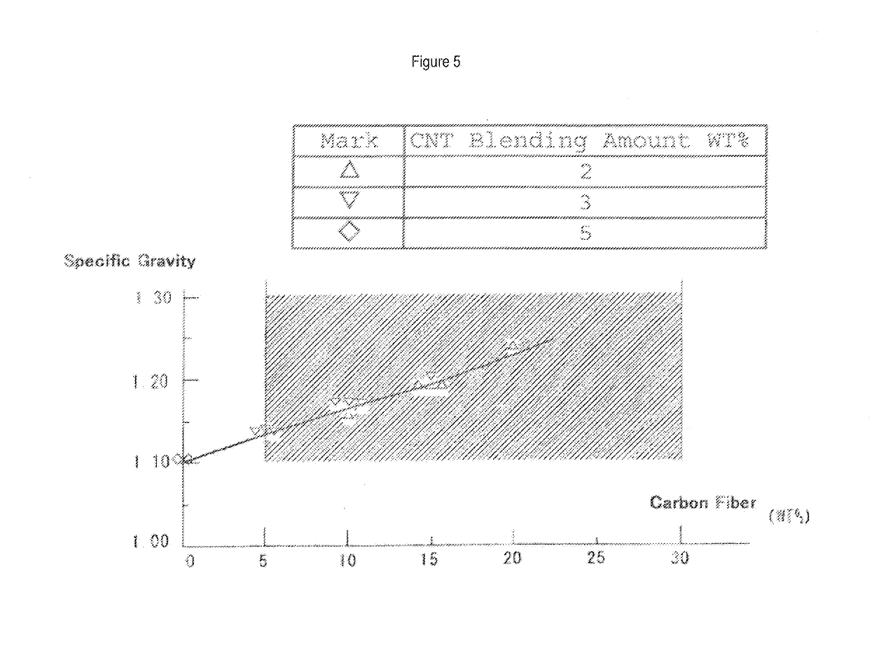

FIG. 5 shows a relation between the specific gravity and the blending rate of carbon fiber in the cases of measurement of the specific gravity among Examples 1 to 30. That is, FIG. 5 shows a relation between the specific gravity and the blending rate of carbon fiber when the blending rate of carbon nanotubes is set at 2, 3 and 5 wt % when the blending rate of carbon fiber is in the range of 0 to 30 wt %. As shown in FIG. 5, when carbon fiber is not blended, the specific gravity is as low as about 1.10, and the specific gravity increases approximately linearly when the blending rate of carbon fiber increases.

In view of the relation with the heat resistant temperature shown in FIG. 4 described above, it could be confirmed that a heat resistant temperature of 140 to 150° C. can be obtained while suppressing the specific gravity at 1.1 to 1.2 when the blending rate of carbon fiber is 5 to 15 wt %. When the blending rate of carbon fiber is increased to 15 to 30 wt %, it can be expected that a heat resistant temperature of 150 to 160° C. is obtained while suppressing the specific gravity at 1.2 to 1.3.

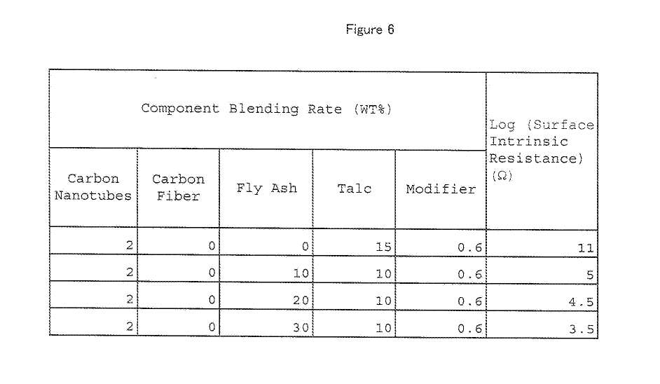

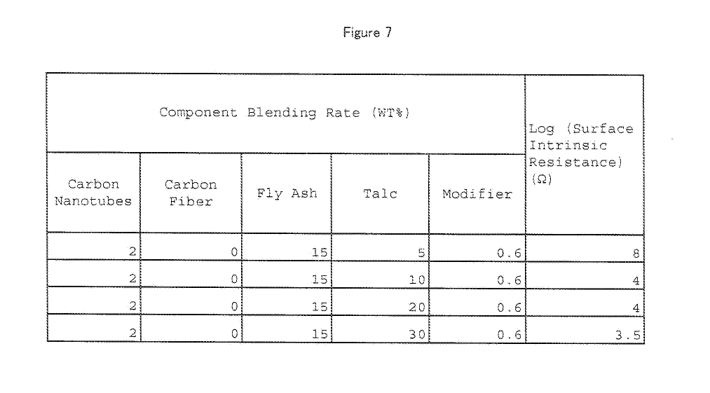

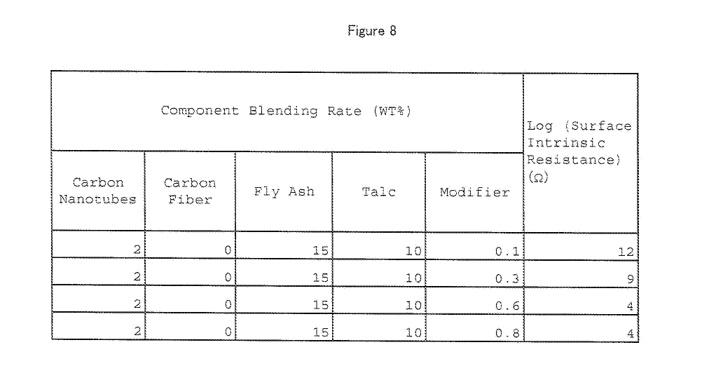

FIGS. 6, 7 and 8 show the results of measurement of the surface intrinsic resistance value when the blending rates of fly ash, talc and a modifier as other components are changed. in all cases, the blending rate of carbon nanotubes is set at a constant value of 2 wt % and carbon fiber is not blended.

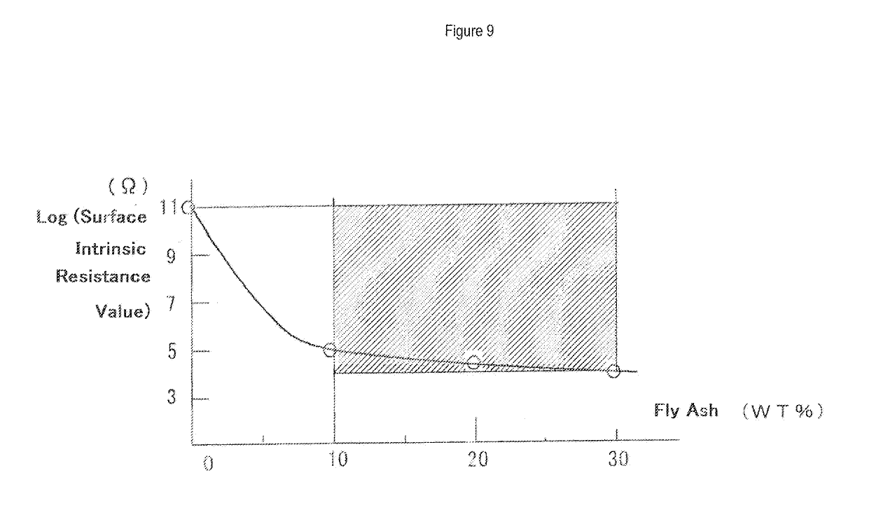

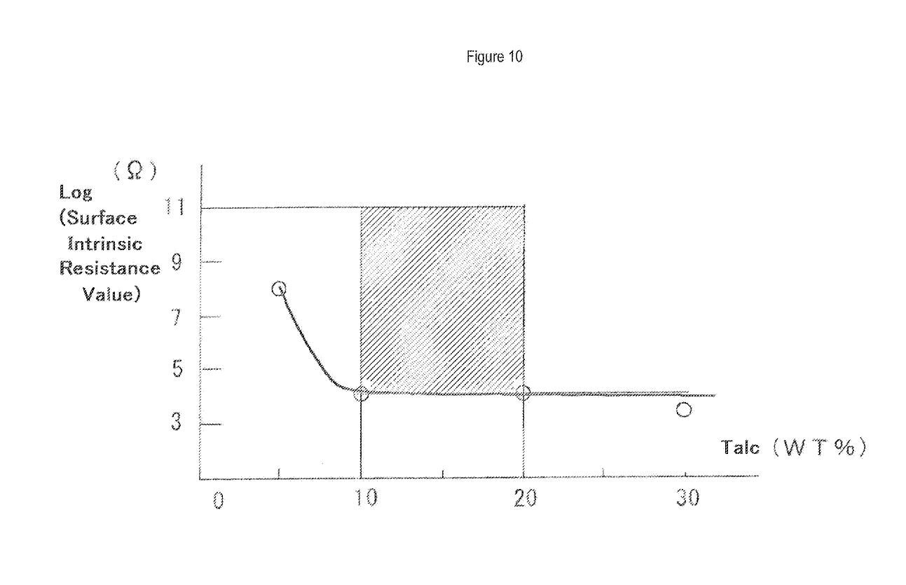

FIG. 9 shows a relation between the surface intrinsic resistance value and the blending rate of fly ash. That is, it could be confirmed that when the blending rate of fly ash is 10 wt % or less, the surface intrinsic resistance value increases drastically, while when the blending rate of fly ash is in the range of 1 to 30 wt %, the surface intrinsic resistance value is converged in a narrow range of 10⁴ to 10⁵ Ω. FIG. 10 shows a relation between the surface intrinsic resistance value and the blending rate of talc. That is, it could be confirmed that when the blending rate of talc is 10 wt % or lower, the surface intrinsic resistance value increases drastically, while when the blending rate of talc is in the range of 10 to 20 wt %, the surface intrinsic resistance value is converged to approximately 10⁴ Ω.

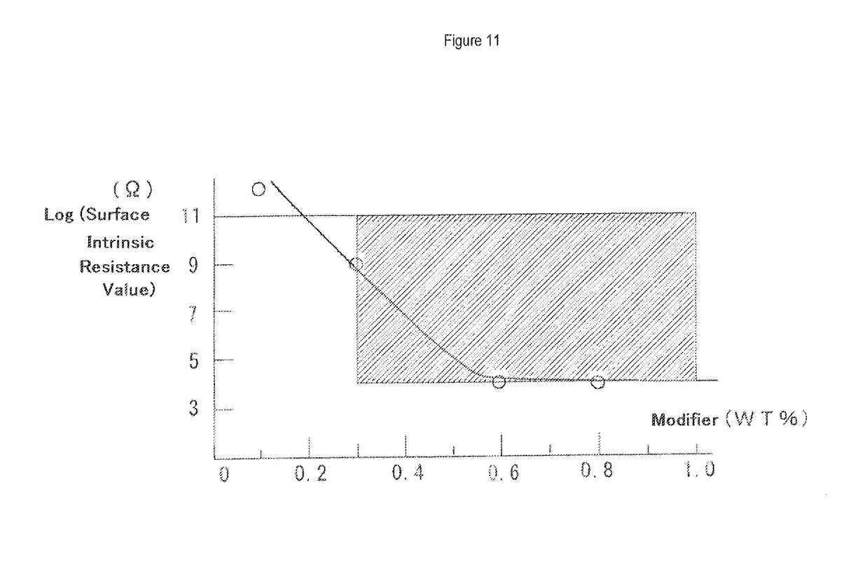

FIG. 11 shows a relation between the surface intrinsic resistance value and the blending rate of a modifier. That is, it could be confirmed that when the blending rate of a modifier is 0.3 wt % or less, the surface intrinsic resistance value is as high as 10⁹ Ω or more, while when the blending rate is in the range of 0.3 to 0.6 wt %, the surface intrinsic resistance value lowers to 10⁴ to 10⁹ Ω and when the blending rate is in the range of 0.6 to 1.0 wt %, the surface intrinsic resistance value is converged to approximately 10⁴ Ω.

According to the above described results, it could be confirmed that when fly ash, talc or a modifier is blended, each of them is capable of lowering the surface intrinsic resistance value significantly, and in a predetermined range of the blending rate, the influence on the surface intrinsic resistance value converges to an approximately constant level.

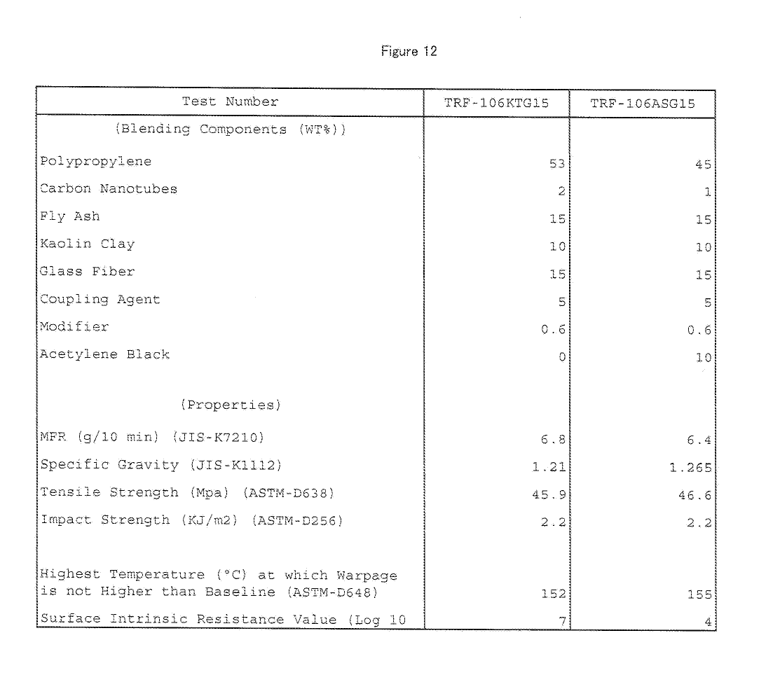

FIG. 12 shows the properties of an electroconductive thermoplastic resin for two examples of blending glass fiber (test number: TRF-1O6KTG15 and TRF-106ASG15) for suppressing generation of warpage. Components constituting this electroconductive thermoplastic resin are as shown below. That is, pellets of polypropylene “SunAllomer PM900A” manufactured by Sun Allomer Ltd. as a crystalline thermoplastic resin, vapor grown carbon fiber “VGCF(registered trademark)-X” (fiber diameter 15 nm, fiber length 3 nm) manufactured by Showa Denko K.K. as carbon nanotubes, fly ash having an average particle size of 10 to 30 μm manufactured by J Power/EPDC as coal ash, kaolin clay “Burgess NO. 30” manufactured by U.S. Burgess Pigment Company as an inorganic filler, “TP69A” (average fiber length:3.3 mm., average fiber diameter:13.5 μ) manufactured by Owens Corning Corporation as glass fiber, “ADTEX ER320P” manufactured by Japan Polychem Corporation as a coupling agent and “Excel T-95” manufactured by Kao Corporation as a modifier were used The baseline of warpage was determined to 0.5 mm or less, and the temperature at which warpage generated could be maintained at 0.5 mm or less was measured.

As shown in the test number “TRF-106KTG15” in FIG. 12, it was clarified that when 15 wt % of glass fiber and 5 wt % of a coupling agent are blended, the baseline of warpage of 0.5 mm or less is satisfied even at a sufficiently high temperature of 152° C. As shown in the test number “TRF-106ASG15” in FIG. 12, it was clarified that when 10 wt % of acetylene black is blended, the temperature satisfying the baseline of warpage of 0.5 mm or less can be maintained at a high level of 155° C. even if the blending rate of carbon nanotubes is as small as 1 wt %.

### INDUSTRIAL APPLICABILITY

Since an inexpensive lightweight electroconductive thermoplastic resin excellent in dust-proofness, heat resistance and recyclability can be provided, the present invention can be utilized widely in industries regarding thermoplastic resins, particularly industries regarding packaging containers, conveying trays and the like for semiconductor devices, optical lenses and the like.

1. An electroconductive thermoplastic resin comprising a crystalline thermoplastic resin blended with 1 to 5 wt % of carbon nanotubes, 10 to 30 wt % of coal ash generated in a powdered coal combustion boiler, 10 to 20 wt % of an inorganic filler and 0.3 to 1 wt % of a modifier.

2. An electroconductive thermoplastic resin characterized in that a crystalline thermoplastic resin is blended with 1 to 2 wt % of carbon nanotubes, 5 to 30 wt % of carbon fiber, 10 to 30 wt % of coal ash generated in a powdered coal combustion boiler, 10 to 20 wt % of an inorganic filler, and 0.3 to 1 wt % of a modifier.

3. An electroconductive thermoplastic resin characterized in that a crystalline thermoplastic resin is blended with 1 to 3 wt % of carbon nanotubes, 5 to 20 wt % of carbon fiber, 10 to 30 wt % of coal ash generated in a powdered coal combustion boiler, 10 to 20 wt % of an inorganic filler, and 0.3 to 1 wt % of a modifier.

4. An electroconductive thermoplastic resin characterized in that a crystalline thermoplastic resin is blended with 0.5 to 2 wt % of carbon nanotubes, 20 to 30 wt % of carbon fiber, 10 to 30 wt % of coal ash generated in a powered coal combustion boiler, 10 to 20 wt % of an inorganic filler, and 0.3 to 1 wt % of a modifier.

5. The electroconductive thermoplastic resin according to any one of claims 1 to 4, wherein said inorganic filler is talc.

6. The electroconductive thermoplastic resin according to any one of claims 1 to 4 characterized in that the thermoplastic resin is any one of polypropylene, polyvinylidene fluoride, polyphenylene ether, polyphenylene oxide, polyamideimide, polycarbonate, polystyrene, and ABS, or a combination of two or more of them.

7. The electroconductive thermoplastic resin according to claim 1, wherein, further, 5 to 25 wt % of glass fiber and 4 to 6 wt % of a coupling agent are blended with respect to said crystalline thermoplastic resin.
